(19) United States
(12) Patent Application Publication
(10) Pub. No.: US 2016/0309766 A1
(43) Pub. Date: Oct. 27, 2016

(54) AN AGE-TAILORED NUTRITION SYSTEM FOR AN INFANT

(71) Applicant: NESTEC S.A., Vevey (CH)

(72) Inventors: Carlos Antonio DeCastro, Geneva (CH); Yongcheng Liao, Beijing (CN); Celia Ning, Beijing (CN); Junkuan Wang, Beijing (CN); Ying Xia, Beijing (CN)

(21) Appl. No.: 15/103,931

(22) PCT Filed: Sep. 9, 2014
(86) PCT No.: PCT/EP2014/069129

§ 371 Date: Jun. 13, 2016

(30) Foreign Application Priority Data
Dec. 12, 2013 (CN) PCT/CN2013/089263

(51) Int. Cl. A23L 33/00; A23L 33/16

(52) U.S. Cl. CPC A23L 33/40; A23L 33/30; A23L 33/16; A23V 2002/00

(57) ABSTRACT

The present invention relates to an infant formula being designed to meet the nutritional requirement of an infant and having a phosphorus source and a calcium source such that the Ca/P ratio is from more than 2.0:1 to 2.5:1, and relates to an age-tailored nutrition system for an infant, comprising a first, a second and an optional third infant formulae being designed to meet the nutritional requirement of an infant from birth to two month, from above two to six months and from above six to twelve months respectively, each formula having a Ca/P ratio between 1.0:1 and 2.5:1, wherein the Ca/P ratio in each later stage formula is higher than that in the former infant formula, and wherein at least one of the first, second and optional third infant formulae has a Ca/P ratio from more than 2.0:1 to 2.5:1. The present invention also relates to the use of the infant formula or the age-tailored nutrition system for preparation of a kit for improving bone development of an infant from birth.

### FIELD OF THE INVENTION

This invention relates to an infant formula and an age tailored nutrition system for infants comprising at least two infant formulae.

### BACKGROUND OF THE INVENTION

Research into the components of human milk has been going on for many years and is by no means complete even now. However, it has been known for some time that the composition of human milk changes appreciably with duration of lactation.

Mother's milk is recommended for all infants. However, in some cases breast feeding is inadequate or unsuccessful for medical reasons or the mother chooses not to breast feed. Infant formulae have been developed for these situations. Conventional infant formulae fall into two categories, first stage formulae for infants from the age of birth to six months and which provide complete nutrition for this age group and second stage formulae for infants between the ages of six months and twelve months which are fed to the infants in combination with increasing amounts of other foods such as infant cereals and puréed fruits, vegetables and other foodstuffs as the process of weaning progresses.

Among the nutritional components, calcium is one of the most concerned elements for a mother who cannot breast feed infants or chooses not to breast feed, as it is known that calcium has favorable effect on bone development of infants, even on the bone developments at later life stages. Typically, the calcium content in commercially available infant formulae is between 300 and 700 mg/100 g for the first stage of 0 to 6 months; and between 500 and 900 mg/100 g for the second stage of 6 to 12 months.

For the benefit of infants that will not be completely breast-fed in the first few months of life, there is a continuing need to develop infant formulae which will replicate human milk as far as possible in terms of its nutritional properties. Particularly, there is a need for infant formulae which can sufficiently improve the bone development of infants that will not be completely breast-fed in the first few months of life and the later growing stage.

It is known in the art that the ratio of calcium to phosphorus in infant formulae play more important role in bone development than the content of calcium alone in infant formulae.

In infant formula the calcium to phosphorus ratio is importantly regulated according to standard and can only vary within a well established range. That range also corresponds to the currently accepted scientific knowledge for inducing the best infant development, in particular the development of the bones and future teeth.

The ratio of calcium to phosphorus in the commercially available infant formula products is from 1.0:1 to 2.0:1. Surprisingly it has been found that it is lower than the observed ratio of calcium to phosphorus in human breast milk, especially Chinese mother breast milk, which can be seen from the results of an investigation regarding minerals in breast milk in China. This study will be described in detail below.

In addition, both the conventional first and second stage infant formulae, especially the first stage infant formula, have constant ratio of calcium to phosphorus during a period from 0 to 6 months. It was surprisingly found by the inventors that the ratio of calcium to phosphorus in human breast milk will undergo appreciable changes during the first six months of infant life. That is to say, the commercially available first stage infant formulae for all of the first six months of infant life can not provide desirable ratio of calcium to phosphorus like breast milk for bone development.

It is therefore an object of the invention to provide infant formulae with optimal ratio of calcium to phosphorus for bone development and other calcium induced development such as future teeth.

It is also an object of the invention to provide infant formulae which mimic human breast milk as far as possible in terms of nutritional properties, especially in terms of the ratio of calcium to phosphorus.

### SUMMARY OF THE INVENTION

In order to mimic human breast milk, the inventors carried out an investigation in China to characterize the nutrients composition of Chinese mother milk. The results of mineral nutrients in the statistical report of breast milk of Chinese lactating mothers are briefly provided below.

Study Design

This is an observational, cross sectional, multi-center study aiming at evaluating nutrients composition of breast milk and nutrition intake of Chinese lactating mothers in 3 cities in China.

Study Population
Number of subjects

Total 540 healthy subjects were enrolled, allowing a drop-out rate of 10 percent.

They were comprised of:
480 Lactating mothers in 3 cities (Beijing, Suzhou and Guangzhou)
30 mothers per city for each of the 5 time points (5-11 days, 1 month, 2 months, 4 months and 8 months)

Inclusion/Exclusion Criteria
Inclusion: Healthy Chinese lactating mothers without history of acute and chronic diseases; exclusively breast feeding mothers during 4 months after delivery were enrolled.
Exclusion: Chinese lactating mothers having history of psychopath tendencies and having no dietary memory.

Results

Summary statistics of Mineral contents in breast milk

| | | | | | |
|---|---|---|---|---|---|
| months | N | Min | Mean | SD | Max |

Calcium (mg/kg)

| | | | | | |
|---|---|---|---|---|---|
| 0 | 90 | 192.00 | 303.32 | 52.45 | 419.00 |
| 1 | 90 | 151.00 | 293.16 | 46.27 | 397.00 |
| 2 | 90 | 206.00 | 309.27 | 42.99 | 432.00 |
| 4 | 90 | 198.00 | 287.44 | 39.99 | 406.00 |
| 8 | 90 | 150.00 | 267.59 | 43.43 | 462.00 |

Copper (mg/kg)

| | | | | | |
|---|---|---|---|---|---|
| 0 | 90 | 0.16 | 0.56 | 0.15 | 0.93 |
| 1 | 89 | 0.26 | 0.49 | 0.14 | 1.10 |
| 2 | 90 | 0.15 | 0.35 | 0.09 | 0.59 |
| 4 | 90 | 0.13 | 0.31 | 0.07 | 0.47 |
| 8 | 86 | 0.11 | 0.28 | 0.09 | 0.64 |

Iodine (μg/kg)

| | | | | | |
|---|---|---|---|---|---|
| 0 | 89 | 53.00 | 293.63 | 157.29 | 946.00 |
| 1 | 89 | 62.00 | 223.35 | 121.47 | 618.00 |
| 2 | 85 | 51.00 | 188.09 | 91.33 | 680.00 |
| 4 | 88 | 51.00 | 175.28 | 75.99 | 484.00 |
| 8 | 90 | 59.00 | 185.96 | 96.35 | 594.00 |

Phosphorus (mg/kg)

| | | | | | |
|---|---|---|---|---|---|
| 0 | 90 | 66.00 | 143.79 | 33.64 | 214.00 |
| 1 | 90 | 73.00 | 147.88 | 24.64 | 228.00 |
| 2 | 90 | 93.00 | 136.08 | 19.48 | 182.00 |
| 4 | 90 | 88.00 | 118.02 | 18.39 | 192.00 |
| 8 | 90 | 35.00 | 113.58 | 19.45 | 198.00 |

Potassium (mg/kg)

| | | | | | |
|---|---|---|---|---|---|
| 0 | 90 | 438.00 | 665.89 | 111.00 | 1001.00 |
| 1 | 90 | 423.00 | 600.34 | 79.03 | 832.00 |
| 2 | 90 | 375.00 | 537.10 | 63.30 | 715.00 |
| 4 | 90 | 352.00 | 489.12 | 61.36 | 649.00 |
| 8 | 90 | 356.00 | 459.26 | 47.94 | 614.00 |

Sodium (mg/kg)

| | | | | | |
|---|---|---|---|---|---|
| 0 | 89 | 87.0 | 360.3 | 225.7 | 1220.0 |
| 1 | 89 | 97.0 | 230.8 | 190.9 | 1280.0 |
| 2 | 90 | 60.0 | 140.3 | 67.5 | 510.0 |
| 4 | 90 | 41.0 | 130.3 | 68.8 | 45.00 |
| 8 | 90 | 39.0 | 120.1 | 92.4 | 810.0 |

Zinc (mg/kg)

| | | | | | |
|---|---|---|---|---|---|
| 0 | 90 | 0.89 | 3.87 | 1.52 | 9.90 |
| 1 | 90 | 0.91 | 2.85 | 1.16 | 7.30 |
| 2 | 90 | 0.66 | 1.98 | 0.68 | 4.10 |
| 4 | 89 | 0.52 | 1.47 | 0.61 | 3.50 |
| 8 | 86 | 0.57 | 1.25 | 0.50 | 2.90 |

According to above results, the inventors performed statistical analysis and surprisingly found the ratio of calcium and phosphorus gradually increases during this period, especially from 0 to 6 months, more especially from 0 to 2 months. It was surprisingly found by the inventors that the ratio of calcium to phosphorus in human breast milk is from more than 2.0:1 to 2.5:1 which is more than the known ratio of calcium to phosphorus in commercial available infant formulae, and this ratio gradually increases during the first six months of infant life, especially from 0 to 2 months, as can be seen from the curve of Ca/P ratio in FIG. 1. Based on these unexpected findings, the present invention provides a modified infant formula or an age-tailored nutrition system to improve bone development of an infant and later life stage.

More particularly, the present invention relates to the following aspects.

1). An infant formula being designed to meet the nutritional requirement of an infant and having a phosphorus source and a calcium source such that the calcium:phosphorus ratio is from more than 2.0:1 to 2.5:1.

2). An infant formula according to the above aspect 1), which is designed to meet the nutritional requirement of an infant from birth to two months and wherein the calcium:phosphorus ratio is from more than 2.0:1 and 2.3:1.

3). An infant formula according to the above aspect 1), which is designed to meet the nutritional requirement of an infant from above two to six months and wherein the calcium:phosphorus ratio is between 2.2:1 and 2.5:1.

4). An infant formula according to the above aspect 1), which is designed to meet the nutritional requirement of an infant from above six to twelve months and wherein the calcium:phosphorus ratio is between 2.4:1 and 2.5:1.

5). An infant formula according to any of the above aspects 1) to 4), which comprises at least one additional components selected from lipids, minerals other than calcium and phosphorus, vitamins, lactoferrin, probiotics, prebiotics, proteins, carbohydrates, or any mixtures thereof.

6). An infant formula according to the above aspect 1) to 5), wherein the lipids are long-chain polyunsaturated fatty acids, preferably selected from docosahexaenoic acid (DHA), arachidonic acid (ARA), eicosapentaenoic acid (EPA) and dihomo-gamma-linolenic acid (DGLA), medium-chain triglycerides, milk fat globule membranes (MFGM), or any mixtures thereof.

7). An infant formula according to any of the above aspects 1) to 6), which comprises minerals other than calcium and phosphorus, selected from the group consisting of copper, magnesium, potassium, iron, selenium, sodium, zinc, manganese, chloride and iodine.

8). An infant formula according to any of the above aspects 1) to 7), which comprises probiotics selected from Bifidobacterium, Lactobacillus, or any mixtures thereof.

9). An infant formula according to any of the above aspects 1) to 8), which comprises a protein source comprising whey, casein or mixture thereof.

10). An infant formula according to the above aspect 9), which comprises whey and optional casein, the whey:casein ratio being chosen in the range from 100:0 to 40:60.

11). An infant formula according to the above aspect 9) to 10), wherein the whey:casein ratio of each formula is chosen in the range from 70:30 to 50:50.

12). An infant formula according to any of the above aspects 1) to 11), which is in the form of a powder to be reconstituted or a concentrate to be diluted.

13). An infant formula according to any of the above aspects 1) to 12), which is packed in a form of a capsule or a can.

14). An infant formula according to any of the above aspects 1) to 13) for use in improving bone development of infants from birth.

15). An age-tailored nutrition system for an infant, comprising:
a first infant formula being designed to meet the nutritional requirement of an infant from birth to two months and having a phosphorus source and a calcium source such that the calcium:phosphorus ratio is between 1.0:1 and 2.5:1, and
a second infant formula being designed to meet the nutritional requirement of an infant from above two to six months and having a phosphorus source and a calcium source such that the calcium:phosphorus ratio is between 1.0:1 and 2.5:1, and
optionally, a third infant formula being designed to meet the nutritional requirement of an infant from above six to twelve months and having a phosphorus source and a calcium source such that the calcium:phosphorus ratio is between 1.0:1 and 2.5:1,
wherein the calcium:phosphorus ratio in the second infant formula is higher than that in the first infant formula, and the calcium:phosphorus ratio in the optional third infant formula is higher than that in the second infant formula, and wherein at least one of the first, second and optional third infant formulae has a calcium:phosphorus ratio from more than 2.0:1 to 2.5:1.

16). An age-tailored nutrition system for an infant according to the above aspect 15), comprising:
a first infant formula being designed to meet the nutritional requirement of an infant from birth to two months and having a phosphorus source and a calcium source such that the calcium:phosphorus ratio is from more than 2.0:1 to 2.5:1, and
a second infant formula being designed to meet the nutritional requirement of an infant from above two to six months and having a phosphorus source and a calcium source such that the calcium:phosphorus ratio is from more than 2.0:1 to 2.5:1, and
optionally, a third infant formula being designed to meet the nutritional requirement of an infant from above six to twelve months and having a phosphorus source and a calcium source such that the calcium:phosphorus ratio is from more than 2.0:1 to 2.5:1.

17). An age-tailored nutrition system according to the above aspect 15) or 16), wherein the first infant formula has a calcium:phosphorus ratio of from more than 2.0:1 to 2.3:1.

18). An age-tailored nutrition system according to any of the above aspects 15) to 17), wherein the second infant formula has a calcium:phosphorus ratio of between 2.2:1 and 2.5:1.

19). An age-tailored nutrition system according to any of the above aspects 15) to 18), wherein the third infant formula has a calcium:phosphorus ratio of between 2.4:1 and 2.5:1.

20). An age-tailored nutrition system according to any of the above aspects 15) to 19), wherein the first infant formula has a phosphorus content between 70 and 42 mg/100 kcal and has a calcium content between 140 and 98 mg/100 kcal.

21). An age-tailored nutrition system according to any of the above aspects 15) to 20), wherein the second infant formula has a phosphorus content between 42 and 38 mg/100 kcal and has a calcium content between 98 and 95 mg/100 kcal.

22). An age-tailored nutrition system according to any of the above aspects 15) to 21), wherein the third infant formula has a phosphorus content lower than 38 mg/100 kcal and has a calcium content lower than 95 mg/100 kcal.

23). An age-tailored nutrition system according to any of the above aspects 15) to 22), wherein each of the first, the second and the optional third infant formulae comprises at least one additional component selected from lipids, minerals other than calcium and phosphorus, vitamins, lactoferrin, probiotics, prebiotics, proteins, carbohydrates, or any mixtures thereof.

24). An age-tailored nutrition system according to the above aspect 23), wherein the lipid is long-chain polyunsaturated fatty acids, preferably selected from docosahexaenoic acid (DHA), arachidonic acid (ARA), eicosapentaenoic acid (EPA) and dihomo-gamma-linolenic acid (DGLA), medium-chain triglycerides, milk fat globule membranes (MFGM), or any mixtures thereof.

25). An age-tailored nutrition system according to any of the above aspects 15) to 24), wherein each of the first, second and optional third infant formulae comprises minerals other than calcium and phosphorus, selected from copper, magnesium, potassium, iron, selenium, sodium, zinc, manganese, chloride and iodine.

26). An age-tailored nutrition system according to the above aspect 25), wherein the content of at least one mineral selected from calcium, iodine, phosphorus, potassium, sodium, copper and zinc in the second infant formula is lower than that in the first infant formula, and the content of said at least one mineral in the optional third infant formula is lower than that in the second infant formula.

27). An age-tailored nutrition system according to the above aspect 26), wherein the contents of at least two, at least three, at least four or at least five of said minerals in the second infant formula are lower than in the first infant formula, and the contents of said at least two, at least three, at least four or at least five of said minerals in the optional third infant formula are lower than in the second infant formula.

28). An age-tailored nutrition system according to the above aspect 26), wherein the contents of iodine, phosphorus, potassium, sodium, copper and zinc in the second infant formula are lower than in the first infant formula, and the contents of said minerals in the optional third infant formula are lower than in the second infant formula.

29). An age-tailored nutrition system according to the above aspect 26), wherein the contents of calcium, iodine, phosphorus, potassium, sodium, copper and zinc in the second infant formula are lower than in the first infant formula, and the contents of said minerals in the optional third infant formula are lower than in the second infant formula.

30). An age-tailored nutrition system according to any of the above aspects 15) to 29), wherein each of the first, second and the optional third infant formulae comprises probiotics selected from Bifidobacterium, Lactobacillus, or any mixtures thereof.

31). An age-tailored nutrition system according to any of the above aspects 15) to 30), wherein each of the first, second and the optional third infant formulae comprises a protein source comprising whey, casein or mixture thereof.

32). An age-tailored nutrition system according to the above aspect 31), wherein each of the first, second and the optional third infant formulae comprises whey and optional casein, and wherein the ratio of whey and casein in the first infant formula is between 100:0 and 60:40 and the protein content is between 2.0 and 3.0 g/100 kcal, and the ratio of whey and casein in the second infant formula is between 70:30 and 50:50 and the protein content is between 1.7 and 2.1 g/100 kcal, with the proviso that either the protein content or the whey:casein ratio of the second formula or both is/are lower than for the first formula.

33). An age-tailored nutrition system according to any of the above aspects 15) to 32), wherein each of the first, the second and the optional third infant formulae is in the form of a powder to be reconstituted or a concentrate to be diluted.

34). An age-tailored nutrition system according to any of the above aspects 15) to 33), wherein the first, the second and the optional third infant formulae are packed in single dose units, each unit comprising sufficient nutritional composition to prepare a single serving upon reconstitution with water.

35). An age-tailored nutrition system according to the above aspect 34), wherein the single dose units are in a form of a capsule or a can.

36). An age-tailored nutrition system according to any of the above aspects 15) to 35) for use in improving bone development of infants from birth.

37). A method of providing nutrition to an infant in the first six months of life, comprising

feeding to the infant for at least part of the first two months of life a first infant formula, and

feeding to the infant for at least part of the following four months of life a second infant formula,

wherein the first infant formula and the second infant formula are as defined in any of the above aspects 15) to 36).

38). A method of providing nutrition to an infant in the first twelve months of life, comprising

feeding to the infant for at least part of the first two months of life a first infant formula,

feeding to the infant for at least part of the following four months of life a second infant formula, and

feeding to the infant for at least part of the remainder of the first twelve months of life a third infant formula,

wherein the first infant formula, the second infant formula and the third infant formula are as defined in any of the above aspects 15) to 36).

39). Use of the infant formula according to any of the above aspects 1) to 14) or the age-tailored nutrition system according to any of the above aspects 15) to 37) for preparation of a kit for improving bone development of an infant from birth.

### BRIEF DESCRIPTION OF FIGURE

FIG. 1 shows curves depicting the change of the ratio of calcium to phosphorus in human breast milk during the first eight months of lactation, which are fitted linear models with background raw observations. Broken lines represent the upper and lower bounds for 95 percent confidence intervals while the solid line represents the model estimates.

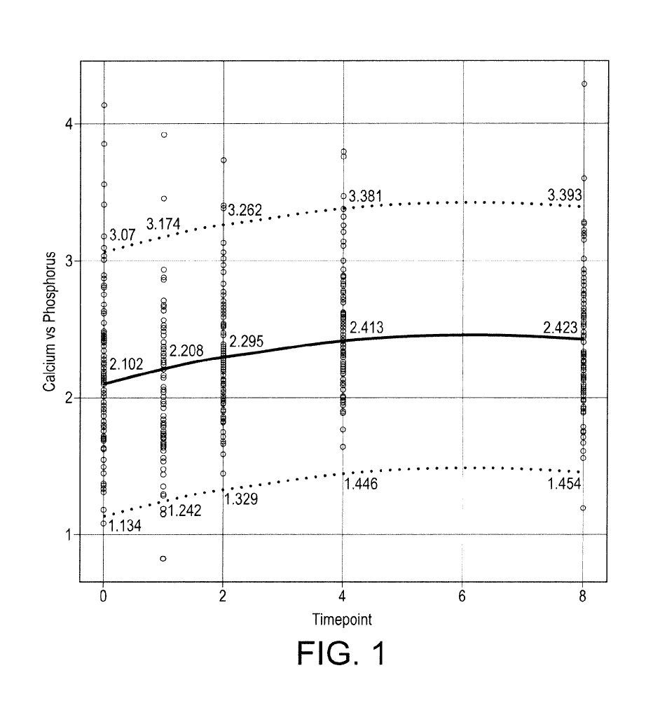

### DETAILED DESCRIPTION OF THE INVENTION

In the present specification, the following words are given a definition that must be taken into account when reading and interpreting the description, examples and claims.

Infant: the term “infant” means children under the age of 12 months. This definition is adopted in the present specification.

Infant formula: The term “infant formula” means foodstuffs intended for particular nutritional use by infants and satisfying by themselves the nutritional requirements of this category of persons. It has to be understood that infants can be fed solely with infant formula, or that the infant formula can be used by the career as a complement of human milk.

Probiotic: according to the paper Probiotics in Man and Animals, J. Appl Bacteriol. 66: 365-378, a probiotic is defined as a live microbial feed supplement which beneficially affects the host animal by improving its intestinal microbial balance.

The present invention relates to an infant formula being designed to meet the nutritional requirement of an infant, which comprises a phosphorus source and a calcium source such that the calcium:phosphorus ratio is from more than 2.0:1 to 2.5:1, preferably between 2.1:1 and 2.5:1.

In a preferable embodiment, the said infant formula according to the present invention is designed to meet the nutritional requirement of an infant from birth to two months and wherein the calcium:phosphorus ratio is from more than 2.0:1 to 2.3:1.

In another preferable embodiment, the said infant formula according to the present invention is designed to meet the nutritional requirement of an infant from above two to six months and wherein the calcium:phosphorus ratio is between 2.2:1 and 2.5:1.

In still another preferable embodiment, the said infant formula according to the present invention is designed to meet the nutritional requirement of an infant from above six to twelve months and wherein the calcium:phosphorus ratio is between 2.4:1 and 2.5:1.

As calcium source to be used in the infant formula according to the present invention, any conventional substances may be used. For example, milk such as cow milk, goat milk may be used, which can provide calcium together with other nutritional substances such as proteins. Organic and/or inorganic calcium salts such as calcium carbonate, calcium lactate, calcium gluconate may also be added as calcium source.

The phosphorus source to be used in the infant formula according to the present invention is also known in the art. Similarly, the phosphorus may be derived from the milk for preparing the infant formula or maybe added deliberately in form of organic and/or inorganic phosphate such as sodium dihydrogen phosphate.

The content of calcium and/or phosphorus in the said infant formula according to the present invention may be chosen in the conventional amounts known in the art with the proviso that the ratio of calcium and phosphorus falls within the ranges as defined hereinabove. Preferably, the phosphorus content in the said infant formula according to the present invention is between 70 and 25 mg/100 kcal. The preferred calcium content in the said infant formula according to the present invention is between 140 and 50 mg/100 kcal.

The said infant formula according to the present invention may comprise any other conventional component sources to meet the nutritional requirement of an infant, such as sources of lipids, minerals other than calcium and phosphorus, vitamins, lactoferrin, probiotics, prebiotics, proteins, carbohydrates, or any mixtures thereof.

The said infant formula according to the present invention may comprise a lipid source. The lipid source may be any lipid or fat which is suitable for use in infant formulae. Preferred fat sources include milk fat, palm olein, high oleic sunflower oil and high oleic safflower oil. Preferably, the said infant formula according to the present invention may comprise a source of long-chain polyunsaturated fatty acids, preferably selected from docosahexaenoic acid (DHA), arachidonic acid (ARA), eicosapentaenoic acid (EPA) and/or dihomo-gamma-linolenic acid (DGLA), or may comprise a source of medium-chain triglycerides, milk fat globule membranes (MFGM), or any mixtures thereof. The lipid source preferably has a ratio of n-6 to n-3 fatty acids of about 5:1 to about 15:1; for example about 8:1 to about 10:1.

The said infant formula according to the present invention may also contain all vitamins and minerals understood to be essential in the daily diet and in nutritionally significant amounts in addition to calcium and phosphorus. Examples of minerals, vitamins and other nutrients optionally present in the infant formula include vitamin A, vitamin B₁, vitamin B₂, vitamin B₆, vitamin B₁₂, vitamin E, vitamin K, vitamin C, vitamin D, folic acid, inositol, niacin, biotin, pantothenic acid, taurine, L-carnitine, choline, calcium, phosphorous, iodine, iron, magnesium, copper, zinc, manganese, chloride, potassium, sodium and selenium. Minerals are usually added in salt form. The presence and amounts of specific minerals and other vitamins will vary depending on the intended infant population.

The said infant formula according to the present invention may also be supplemented with lactoferrin. Lactoferrin is known inter alia to promote the growth and maturation of the gastrointestinal tract in newborn infants.

The said infant formula according to the present invention may also comprise at least one probiotic bacterial strain. Examples of suitable probiotic micro-organisms used include yeasts such as Saccharomyces, Debaromyces, Candida, Pichia and Torulopsis, moulds such as Aspergillus, Rhizopus, Mucor, and Penicillium and Torulopsis and bacteria such as the genera Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus and Lactobacillus. Specific examples of suitable probiotic micro-organisms are: Saccharomyces cereviseae, Bacillus coagulans, Bacillus licheniformis, Bacillus subtilis, Bifidobacterium bifidum, Bifidobacterium breve such as B. breve CNCM I-3865, Bifidobacterium infantis, Bifidobacterium lactis such as B. lactis CNCM I-3446, Bifidobacterium longum such as B. longum CNCM I-2618, B. longum BB536 ATCC BAA-999, B. longum BL999, Enterococcus faecium, Enterococcus faecalis, Lactobacillus acidophilus such as L. acidophilus L92 FERM BP.4981, Lactobacillus alimentarius, Lactobacillus casei subsp. casei, Lactobacillus casei Shirota, Lactobacillus curvatus, Lactobacillus delbruckii subsp. lactis, Lactobacillus farciminus, Lactobacillus fermentum such as L. fermentum VRI-033 PCC strain NM 02/31074, Lactobacillus gasseri, Lactobacillus helveticus such as L. helveticus CNCM I-4095, Lactobacillus johnsonii such as L. johnsonii La1 CNCM I-1225, Lactobacillus paracasei such as L. paracasei ST11 CNCM I-2116, L. paracasei 33, Lactobacillus rhamnosus (Lactobacillus GG) such as L. rhamnosus CGMCC 1.3724 ATCC 53103, Lactobacillus sake, Lactococcus lactis such as L. lactis SL31 CNCM I-4154, Micrococcus varians, Pediococcus acidilactici, Pediococcus pentosaceus, Pediococcus acidilactici, Pediococcus halophilus, Streptococcus faecalis, Streptococcus thermophilus such as S. thermophilus CNCM I-3915, Streptococcus salivarius such as S. salivarius K12 ATCC BAA-1024, Staphylococcus carnosus, and Staphylococcus xylosus, or any mixtures thereof.

Preferred probiotic bacterial strains include Lactobacillus rhamnosus ATCC 53103 obtainable from Valio Oy of Finland under the trade mark LGG, Lactobacillus rhamnosus CGMCC 1.3724, Lactobacillus paracasei CNCM I-2116, Bifidobacterium lactis CNCM I-3446 sold inter alia by the Christian Hansen company of Denmark under the trade mark Bb 12 and Bifidobacterium longum ATCC BAA-999 sold by Morinaga Milk Industry Co. Ltd. of Japan under the trade mark BB536, Bifidobacterium breve CNCM I-3865, Bifidobacterium longum CNCM I-2618, Lactobacillus acidophilus L92 FERM BP.4981 from Calpis, Lactobacillus helveticus CNCM I-4095, Lactobacillus johnsonii La1 CNCM I-1225, Lactococcus lactis SL31 CNCM I-4154, Streptococcus thermophiles CNCM I-3915, Streptococcus salivarius such as S. salivarius K12 ATCC BAA-1024 from BLIS, Lactobacillus paracasei 33 from Uni President, L. fermentum VRI-033 PCC strain NM 02/31074 from Probiomix.

Bifidobacterium such as Bifidobacterium lactis and Lactobacillus such as Lactobacillus rhamnosus are preferably used in the said infant formula according to the present invention.

The amount of probiotic, if present, is preferably present in an amount of 10³ to 10¹² cfu/g, more preferably 10⁶ to 10¹¹ cfu/g, even more preferably 10⁴ to 10⁹ cfu/g, most preferably 10⁷ to 10⁹ cfu/g composition (dry weight).

It may be hypothetized that the calcium to phosphorus ratio in the infant feeding may influence the growth of some probiotics.

Additionally, the said infant formula according to the present invention may comprise prebiotics. If present, the prebiotics are preferably present in the formulae in an amount 1 to 20wt %, preferably 2 to 15wt % on a dry matter basis.

A prebiotic is a non-digestible food ingredient that beneficially affects the host by selectively stimulating the growth and/or activity of one or a limited number of bacteria in the colon, and thus improves host health. Such ingredients are non-digestible in the sense that they are not broken down and absorbed in the stomach or small intestine and thus pass intact to the colon where they are selectively fermented by the beneficial bacteria. Examples of prebiotics include certain oligosaccharides, such as fructooligosaccharides (FOS) and galactooligosaccharides (GOS). A combination of prebiotics may be used such as 90% GOS with 10% short chain fructo-oligosaccharides such as the product sold under the trade mark Raftilose® or 10% inulin such as the product sold under the trade mark Raftiline®.

A particularly preferred prebiotic is a mixture of galacto-oligosaccharide(s), N-acetylated oligosaccharide(s) and sialylated oligosaccharide(s) in which the N-acetylated oligosaccharide(s) comprise 0.5 to 4.0% of the oligosaccharide mixture, the galacto-oligosaccharide(s) comprise 92.0 to 98.5% of the oligosaccharide mixture and the sialylated oligosaccharide(s) comprise 1.0 to 4.0% of the oligosaccharide mixture. This mixture is hereinafter referred to as “CMOS-GOS”.

Preferably, the said infant formula according to the invention contains from 2.5 to 15.0 wt % CMOS-GOS on a dry matter basis with the proviso that the composition comprises at least 0.02 wt % of an N-acetylated oligosaccharide, at least 2.0 wt % of a galacto-oligosaccharide and at least 0.04 wt % of a sialylated oligosaccharide.

Suitable N-acetylated oligosaccharides include GalNAcαl, 3Galβl, 4Glc and Galβl, 6GalNAcαl, 3Galβl, 4Glc. The N-acetylated oligosaccharides may be prepared by the action of glucosaminidase and/or galactosaminidase on N-acetyl-glucose and/or N-acetyl galactose. Bqually, N-acetyl-galactosyl transferases and/or N-acetyl-glycosyl transferases may be used for this purpose. The N-acetylated oligosaccharides may also be produced by fermentation technology using respective enzymes (recombinant or natural) and/or microbial fermentation. In the latter case the microbes may either express their natural enzymes and substrates or maybe engineered to produce respective substrates and enzymes. Single microbial cultures or mixed cultures maybe used. N-acetylated oligosaccharide formation can be initiated by acceptor substrates starting from any degree of polymerisation (DP) from DP=1 onwards. Another option is the chemical conversion of keto-hexoses (e.g. fructose) either free or bound to an oligosaccharide (e.g. lactulose) into N-acetylhexosamine or an N-acetylhexosamine containing oligosaccharide as described in Wrodnigg, T. M.; Stutz, A. E. (1999) Angew. Chem. Int. Ed. 38:827-828.

Suitable galacto-oligosaccharides include Galβl, 6Gal, Galβl, 6Galβl, 4Glc, Galβl, 6Galβl, 6Glc, Galβl, 3Galβl, 3Glc, Galβl, 3Galβl, 4Glc, Galβ1, 6Galβ1, 6Galβ1, 4Glc, Galβ1, 6Galβ1, 3Galβ1, 4Glc, Galβ1, 3Galβ1, 6Galβ1, 4Glc, Galβl, 3Galβl, 3Galβl, 4Glc, Galβl, 4Galβl, 4Glc and Galβl, 4Galβl, 4Galβl, 4Glc.

Synthesised galacto-oligosaccharides such as Galβl, 6Galβl, 4Glc, Galβl, 6Galβl, 6Glc, Galβl, 3Galβl, 4Glc, Galβl, 6Galβl, 6Galβl, 4Glc, Galβl, 6Galβl, 3Galβl, 4Glc and Galβl, 3Galβl, 6Galβl, 4Glc, Galβl, 4Galβl, 4Glc and Galβl, 4Galβl, 4Galβl, 4Glc and mixtures thereof are commercially available under the trademarks Vivinal® and Elix'or®. Other suppliers of oligosaccharides are Dextra Laboratories, Sigma-Aldrich Chemie GmbH and Kyowa Hakko Kogyo Co., Ltd. Alternatively, specific glycosyltransferases, such as galactosyltransferases may be used to produce neutral oligosaccharides.

Suitable sialylaled oligosaccharides include NeuAcα2, 3Galβl, 4Glc and NeuAcα2, 6Galβl, 4Glc. These sialylated oligosaccharides may be isolated by chromatographic or filtration technology from a natural source such as animal milks. Alternatively, they may also be produced by biotechnology using specific sialyltransferases either by enzyme based fermentation technology (recombinant or natural enzymes) or by microbial fermentation technology. In the latter case microbes may either express their natural enzymes and substrates or maybe engineered to produce respective substrates and enzymes. Single microbial cultures or mixed cultures may be used. Sialyl-oligosaccharide formation can be initiated by acceptor substrates starting from any degree of polymerisation (DP) from DP=1 onwards.

The said infant formula may comprise a protein selected from intact or hydrolysed protein, proteins associated with milk fat globule membrane (MFGM), casein, whey, soy protein, or any mixtures thereof. In a preferable embodiment, the said infant formula comprises whey and optional casein and has a whey:casein ratio between 100:0 and 40:60, preferably 70:30 and 50:50. The protein content in the said infant formula is between 1.5 and 3.0 g/100 kcal.

The said infant formula according to the present invention may comprise a carbohydrate source. Any carbohydrate source conventionally found in infant formulae such as lactose, saccharose, maltodextrin, starch or mixtures thereof may be used, although the preferred source of carbohydrate is lactose. Preferably, the amount of lactose in the said infant formula according to the present invention is between 9.5 and 12 g/100 kcal.

The said infant formula according to the present invention may optionally contain other substances which may have a beneficial effect such as nucleotides, nucleosides, and the like. Nucleotides may be selected from cytidine monophosphate (CMP), uridine monophosphate (UMP), adenosine monophosphate (AMP), guanosine monophosphate (GMP) or any mixtures thereof.

The said infant formula according to the present invention is used for feeding an infant, which is very helpful for bone development.

In addition, the invention also relates to a method for providing nutrition to an infant which comprises feeding to an infant the said infant formula according to the present invention as described hereinabove.

In an embodiment of the invention, the said infant formula according to the present invention may be in the form of a powder to be reconstituted or a concentrate to be diluted. In an embodiment of the invention, the said infant formula according to the present invention is packed in single dose units, each unit comprising sufficient nutritional composition to prepare a single serving upon reconstitution with water. Preferably, the units are in the form of capsules or a can.

A single serving generally comprises 8 to 35 g, preferably 10 to 30 g, most preferably 11 to 28 g of powder to be reconstituted with 80 to 300 mL, preferably between 100 mL and 250 mL of water. Alternatively, if the said infant formula is a concentrate, a single serving includes 1 to 50 mL of concentrate to be diluted with 50 to 250 mL of water.

The said infant formula maybe prepared in any suitable manner. For example, an infant formula may be prepared by blending together a protein source, a carbohydrate source, and a fat source in appropriate proportions. If used, emulsifiers may be included in the blend. The vitamins and minerals may be added at this point but are usually added later to avoid thermal degradation. Any lipophilic vitamins, emulsifiers and the like may be dissolved into the fat source prior to blending. Water, preferably water which has been subjected to reverse osmosis, may then be mixed in to form a liquid mixture.

The liquid mixture may then be thermally treated to reduce bacterial loads. For example, the liquid mixture may be rapidly heated to a temperature in the range of about 80° C. to about 110° C. for about 5 seconds to about 5 minutes. This may be carried out by steam injection or by heat exchanger; for example a plate heat exchanger. The liquid mixture may then be cooled to about 60° C. to about 85° C. for example by flash cooling. The liquid mixture may then be homogenized for example in two stages at about 7 MPa to about 40 MPa in the first stage and about 2 MPa to about 14 MPa in the second stage. The homogenized mixture may then be further cooled to add any heat sensitive components such as vitamins and minerals. The pH and solids content of the homogenized mixture are conveniently standardized at this point.

The homogenized mixture is transferred to a suitable drying apparatus such as a spray drier or freeze drier and converted to powder. The powder should have a moisture content of less than about 3% by weight. Alternatively, the homogenized mixture is concentrated.

If it is desired to add probiotic(s), they may be cultured according to any suitable method and prepared for addition to the infant formula by freeze-drying or spray-drying for example. Alternatively, bacterial preparations can be bought from specialist suppliers such as Christian Hansen and Morinaga already prepared in a suitable form for addition to food products such as infant formula. Such bacterial preparations may be added to the powdered infant formula by dry mixing.

The present invention also provides an age-tailored nutrition system for an infant, which mimics human milk during the lactation.

According to the present invention, the said age-tailored nutrition system for an infant comprises:

a first infant formula being designed to meet the nutritional requirement of an infant from birth to two months and having a phosphorus source and

a calcium source such that the calcium:phosphorus ratio is between 1.0:1 and 2.5:1, and

a second infant formula being designed to meet the nutritional requirement of an infant from above two to six months and having a phosphorus source and a calcium source such that the calcium:phosphorus ratio is between 1.0:1 and 2.5:1, and

optionally, a third infant formula being designed to meet the nutritional requirement of an infant from above six to twelve months and having a phosphorus source and a calcium source such that the calcium:phosphorus ratio is between 1.0:1 and 2.5:1,

wherein the calcium:phosphorus ratio in the second infant formula is higher than that in the first infant formula, and the calcium:phosphorus ratio in the optional third infant formula is higher than that in the second infant formula, and wherein at least one of the first, second and optional third infant formulae has a calcium:phosphorus ratio from more than 2.0:1 to 2.5:1.

In a particular embodiment, the said age-tailored nutrition system for an infant comprises

a first infant formula being designed to meet the nutritional requirement of an infant from birth to two months and having a phosphorus source and

a calcium source such that the calcium:phosphorus ratio is from more than 2.0:1 to 2.5:1, and

a second infant formula being designed to meet the nutritional requirement of an infant from above two to six months and having a phosphorus source and a calcium source such that the calcium:phosphorus ratio is from more than 2.0:1 to 2.5:1, and

optionally, a third infant formula being designed to meet the nutritional requirement of an infant from above six to twelve months and having a phosphorus source and a calcium source such that the calcium:phosphorus ratio is from more than 2.0:1 to 2.5:1,

wherein the calcium:phosphorus ratio in the second infant formula is higher than that in the first infant formula, and the calcium:phosphorus ratio in the optional third infant formula is higher than that in the second infant formula.

In a preferable embodiment, the calcium:phosphorus ratio is from more than 2.0:1 to 2.3:1, preferably from 2.1:1 to 2.3:1 in the first infant formula.

In another or a further preferable embodiment, the calcium:phosphorus ratio is between 2.2:1 and 2.5:1 in the second infant formula.

In another or a further preferable embodiment, the calcium:phosphorus ratio is between 2.4:1 and 2.5:1 in the third infant formula.

The calcium source and phosphorus source are those as described hereinabove for the said infant formula according to the present invention.

In General, each infant formula has a phosphorus content between 70 and 25 mg/100 kcal and/or has a calcium content between 140 and 50 mg/100 kcal.

Preferably, in the first infant formula contained in the age-tailored nutrition system according to the present invention, the phosphorus content is between 70 and 42 mg/100 kcal, preferably between 50 and 42 mg/100 kcal and/or the calcium content is between 140 and 98 mg/100 kcal, preferably between 105 and 98. In the second infant formula contained in the age-tailored nutrition system according to the present invention, the phosphorus content is between 42 and 38 mg/100 kcal and/or the calcium content is between 98 and 95 mg/100 kcal. In the third infant formula, if contained in the age-tailored nutrition system according to the present invention, the phosphorus content is lower than 38mg/100 kcal and/or the calcium content is lower than 95 mg/100 kcal.

Each infant formula contained in the age-tailored nutrition system according the present invention may comprise additional component sources to meet the nutritional requirement of an infant, such as sources of lipids, minerals other than calcium and phosphorus, vitamins, lactoferrin, probiotics, prebiotics, proteins, carbohydrates, or any mixtures thereof. The additional components may be derived from the sources as described hereinabove for the said infant formula according to the present invention.

The lipids, minerals other than calcium and phosphorus, vitamins, lactoferrin, probiotics, prebiotics, proteins, carbohydrates may be used in conventional amounts known in the infant formula field, such as those described hereinabove for the said infant formula of the present invention. In addition, the amounts may be varied in the different formulae of the age-tailored nutrition system according the present invention to meet the different nutritional requirements of infant development with age increasing.

In an embodiment, the content of at least one of the minerals selected from the group consisting of calcium, iodine, phosphorus, potassium, sodium, copper and zinc in the second infant formula is lower than in the first infant formula, and the content of the at least one of the minerals in the optional third infant formula is lower than in the second infant formula. More particularly, the contents of at least two, preferably at least three, more preferably at least four, particularly preferably at least five of said minerals in the second infant formula are lower than in the first infant formula, and the contents of said at least two, preferably at least three, more preferably at least four, particularly preferably at least five of said minerals in the optional third infant formula are lower than in the second infant formula.

In a preferable embodiment, said at least two minerals are iodine and phosphorus. In another preferable embodiment, said at least two minerals are iodine and potassium. In another preferable embodiment, said at least two minerals are iodine and sodium. In another preferable embodiment, said at least two minerals are iodine and copper. In another preferable embodiment, said at least two minerals are iodine and zinc. In another preferable embodiment, said at least two minerals are iodine and calcium.

In a preferable embodiment, said at least two minerals are phosphorus and potassium. In another preferable embodiment, said at least two minerals are phosphorus and sodium. In another preferable embodiment, said at least two minerals are phosphorus and copper. In another preferable embodiment, said at least two minerals are phosphorus and zinc. In another preferable embodiment, said at least two minerals are phosphorus and calcium.

In a preferable embodiment, said at least two minerals are potassium and sodium. In another preferable embodiment, said at least two minerals are potassium and copper. In another preferable embodiment, said at least two minerals are potassium and zinc. In another preferable embodiment, said at least two minerals are potassium and calcium.

In a preferable embodiment, said at least two minerals are sodium and copper. In another preferable embodiment, said at least two minerals are sodium and zinc. In another preferable embodiment, said at least two minerals are sodium and calcium.

In a preferable embodiment, said at least two minerals are copper and zinc. In another preferable embodiment, said at least two minerals are copper and calcium. In another preferable embodiment, said at least two minerals are zinc and calcium.

In a preferable embodiment, said at least three minerals are iodine, phosphorus and potassium. In another preferable embodiment, said at least three minerals are iodine, phosphorus and sodium. In another preferable embodiment, said at least three minerals are iodine, phosphorus and copper. In another preferable embodiment, said at least three minerals are iodine, phosphorus and zinc. In another preferable embodiment, said at least three minerals are iodine, phosphorus and calcium.

In a preferable embodiment, said at least three minerals are iodine, potassium and sodium. In another preferable embodiment, said at least three minerals are iodine, potassium and copper. In another preferable embodiment, said at least three minerals are iodine, potassium and zinc. In another preferable embodiment, said at least three minerals are iodine, potassium and calcium.

In a preferable embodiment, said at least three minerals are iodine, sodium and copper. In another preferable embodiment, said at least three minerals are iodine, sodium and zinc. In another preferable embodiment, said at least three minerals are iodine, sodium and calcium.

In a preferable embodiment, said at least three minerals are iodine, copper and zinc. In another preferable embodiment, said at least three minerals are iodine, copper and calcium. In another preferable embodiment, said at least three minerals are iodine, zinc and calcium.

In a preferable embodiment, said at least three minerals are phosphorus, potassium and sodium. In another preferable embodiment, said at least three minerals are phosphorus, potassium and copper. In another preferable embodiment, said at least three minerals are phosphorus, potassium and zinc.

In another preferable embodiment, said at least three minerals are phosphorus, potassium and calcium.

In a preferable embodiment, said at least three minerals are phosphorus, sodium and copper. In another preferable embodiment, said at least three minerals are phosphorus, sodium and zinc. In another preferable embodiment, said at least three minerals are phosphorus, sodium and calcium.

In a preferable embodiment, said at least three minerals are phosphorus, copper and zinc. In another preferable embodiment, said at least three minerals are phosphorus, copper and calcium. In another preferable embodiment, said at least three minerals are phosphorus, zinc and calcium.

In a preferable embodiment, said at least three minerals are potassium, sodium and copper. In another preferable embodiment, said at least three minerals are potassium, sodium and zinc. In another preferable embodiment, said at least three minerals are potassium, sodium and calcium.

In a preferable embodiment, said at least three minerals are potassium, copper and zinc. In another preferable embodiment, said at least three minerals are potassium, copper and calcium.

In a preferable embodiment, said at least three minerals are sodium, copper and zinc. In another preferable embodiment, said at least three minerals are sodium, copper and calcium. In another preferable embodiment, said at least three minerals are sodium, zinc and calcium.

In a preferable embodiment, said at least three minerals are copper, zinc and calcium.

In a particularly preferable embodiment, the contents of iodine, phosphorus, potassium, sodium, copper and zinc in the second infant formula are lower than in the first infant formula, and the contents of said minerals in the optional third infant formula are lower than in the second infant formula.

In a very particularly preferable embodiment, the contents of calcium, iodine, phosphorus, potassium, sodium, copper and zinc in the second infant formula are lower than in the first infant formula, and the contents of said minerals in the optional third infant formula are lower than in the second infant formula.

In any of above embodiments, the content of iodine in the first infant formula is from 50.0 μg/100 kcal to 16.5 μg/100 kcal, preferably from 26.0 μg/100 kcal to 16.5 μg/100 kcal, the content of iodine in the second infant formula is from 16.5 μg/100 kcal to 14.0 μg/100 kcal, and the content of iodine in the optional third infant formula is lower than 14.0 μg/100 kcal.

In any of above embodiments, the content of potassium in the first infant formula is from 170 mg/100 kcal to 85 mg/100 kcal, preferably from 115 mg/100 kcal to 85 mg/100 kcal, the content of potassium in the second infant formula is from 85 mg/100 kcal to 80 mg/100 kcal, and the content of potassium in the optional third infant formula is lower than 80 mg/100 kcal.

In any of above embodiments, the content of sodium in the first infant formula is from 58 mg/100 kcal to 25 mg/100 kcal, preferably from 50 mg/100 kcal to 25 mg/100 kcal, the content of sodium in the second infant formula is from 25 mg/100 kcal to 22 mg/100 kcal, and the content of sodium in the optional third infant formula is lower than 22 mg/100 kcal.

In any of above embodiments, the content of copper in the first infant formula is from 120 μg/100 kcal to 62 μg/100 kcal, preferably from 110 μg/100 kcal to 62 μg/100 kcal, the content of copper in the second infant formula is from 62 μg/100 kcal to 55 μg/100 kcal, and the content of copper in the optional third infant formula is lower than 55 μg/100 kcal.

In any of above embodiments, the content of zinc in the first infant formula is from 1.5 mg/100 kcal to 0.7 mg/100 kcal, the content of zinc in the second infant formula is from 0.7 mg/100 kcal to 0.6 mg/100 kcal, and the content of zinc in the optional third infant formula is lower than 0.6 mg/100 kcal.

In another preferable embodiment, the first infant formula contained in the age-tailored nutrition system according the present invention comprises whey and optional casein and has a whey:casein ratio between 100:0 and 60:40, and a protein content between 2.0 and 3.0 g/100 kcal, and the second infant formulae contained in the age-tailored nutrition system according the present invention comprises whey and casein and has a whey:casein ratio between 70:30 and 50:50 and a protein content between 1.7 and 2.1 g/100 kcal with the proviso that either the protein content or the whey:casein ratio of the second infant formula or both is/are lower than for the first formula.

Each infant formula contained in the age-tailored nutrition system according the present invention may be prepared by the same process as described hereinabove for the said infant formula according to the present invention.

The age-tailored nutrition system according to the invention is used for feeding an infant from birth to six or twelve months. Thus, the present invention also relates to a method for providing nutrition to an infant, which comprises feeding to an infant the said age-tailored nutrition system as described herein at the corresponding ages.

In one embodiment of the present invention, the present invention provides a method of providing nutrition to an infant in the first six months of life, comprising

feeding to the infant for at least part of the first two months of life a first infant formula, and

feeding to the infant for at least part of the following four months of life a second infant formula,

wherein the first infant formula and the second infant formula are as defined above.

In a further embodiment of the present invention, the present invention provides a method of providing nutrition to an infant in the first twelve months of life, comprising

feeding to the infant for at least part of the first two months of life a first infant formula,

feeding to the infant for at least part of the following four months of life a second infant formula, and

feeding to the infant for at least part of the remainder of the first twelve months of life a third infant formula,

wherein the first infant formula, the second infant formula and the third infant formula are as defined above.

In an embodiment of the invention, the formulae of the age-tailored nutrition system according to the invention are packed in single dose units, each unit comprising sufficient nutritional composition to prepare a single serving upon reconstitution with water. Preferably, the units are in the form of capsules or a can.

A single serving generally comprises 8 to 35 g, preferably 10 to 30 g, most preferably 11 to 28 g of powder to be reconstituted with 80 to 300 mL, preferably between 100 mL and 250 mL of water. Alternatively, in case of concentrates, a single serving includes 1 to 50 mL of concentrate to be diluted with 50 to 250 mL of water.

The capsules maybe disposable capsules equipped with opening means contained within the capsule to permit draining of the reconstituted formula directly from the capsule into a receiving vessel such as a bottle. Such a method of using capsules for dispensing an infant nutritional formula is described in WO2006/077259. The different nutritional formulae of the age-tailored nutrition system according to the invention may be packed into individual capsules and presented to the consumer in multipacks containing a sufficient number of capsules to meet the requirements of an infant for one week for example. Suitable capsule constructions are disclosed in WO2003/059778.

The age-tailored nutrition system according to the invention is also used for improving bone development from birth.

The present invention also relates to use of the age-tailored nutrition system as described above for preparation of a kit for improving bone development of an infant from birth.

The present invention is further illustrated hereinafter by means of the following non-limiting examples.

### EXAMPLES

### Example 1

An array of age-tailored infant formulae is given in the table below. For each formula, 13.08 g powder was added into 90 mL water to provide 100 mL reconstituted milk.

| | | Age range | | |
|---|---|---|---|---|
| | | 0 to 2 months | 2 to 6 months | 6 to 12 months |
| Basics | Reconstitution | 100 to 200 | 100 to 200 | 230 |
| | RTD Volume (ml) | | | |
| | Energy density | 63-67 | 63-67 | 63 |
| | (kcal/100 ml) | | | |
| Protein | Content | 1.8-2.25 | 1.8-2.25 | 1.8 |
| | (g/100 kcal) | | | |
| | Content (g/l) | 11.3-15.1 | 11.3-15.1 | 11.3 |
| | Whey:Casein | 70:30 | 70:30 | 50:50 |
| | Functional | . | . | |
| | proteins | | | |
| Carbo- | Type | Lactose | Lactose | Lactose |
| hydrates | Content | 9.7 to 11.6 | 9.7 to 11.6 | 10.6 |
| | (g/100 kcal) | | | |
| | Content (g/l) | 65.0 to 73.5 | 65.0 to 73.5 | 66.8 |
| Lipids | Type | Milk & Veg. | Milk & Veg. | Milk & Veg. |
| | Content | 5.1 to 5.8 | 5.1 to 5.8 | 5.6 |
| | (g/100 kcal) | | | |
| | content (as % of | 45.9 to 52.2 | 45.9 to 52.2 | 45.8 |
| | total energy) | | | |
| | Content (g/l) | 32.1 to 38.9 | 32.1 to 38.9 | 35.3 |
| | LC-PUFA | DHA + ARA | DHA + ARA | DHA + ARA |
| Soluble | Content | | | |
| Fibers | (g/100 kcal) | | | |
| Probiotics | Type | B. lactis | B. lactis | |
| | | | Or | |
| | | | Bifidobacterium | |
| | | | longum | |
| | | | ATCC BAA-999 | |
| | Content | 2 × 10⁷ cfu/g | 2 × 10⁷ cfu/g | |
| | | | or 10⁹ cfu/g | |
| Nucleotides | CMP (mg/100 kcal) | 1.1 | 1.1 | — |
| | UMP | 0.7 | 0.7 | — |
| | AMP | 0.7 | 0.7 | — |
| | GMP | 0.2 | 0.2 | — |
| | NucleoPremix | | | — |
| Minerals | Na (mg) | 40 | 24 | 21 |
| (/100 kcal) | K (mg) | 105 | 81 | 70 |
| | Na/K (molar | 0.65 | 0.5 | 0.5 |
| | ratio) | | | |
| | (Na + K)/Cl molar | 1.71 to 1.81 | 1.71 to 1.81 | 1.71 |
| | ratio | | | |
| | Cl (mg) | 87 to 92 | 61 to 65 | 56 |
| | Ca (mg) | 100 | 97 | 90 |
| | P (mg) | 47 | 42 | 37 |
| | Mg (mg) | 7 | 7 | 7 |
| | Mn (μg) | 5 | 5 | 5 |
| | Ca/P | 2.13 | 2.31 | 2.43 |
| | Fe (mg) | 0.7 | 0.7 | 1 |
| | I (μg) | 25 | 15 | 13 |
| | Cu (μg) | 100 | 60 | 53 |
| | Zn (mg) | 1.2 | 0.65 | 0.55 |
| | Se (μg) | 3 to 4 | 3 to 4 | 3 |
| | F (μg) | | | — |
| Vitamins | Vit. A (mg RE) | 0.09 to 0.1125 | 0.09 to 0.1125 | 0.09 |
| (/100 kcal) | Beta carotene | | | |
| | (μg) | | | |
| | Vit. D (mg) | 0.0015 | 0.0015 | 0.0015 |
| | Vit. E (mg) | 1.3 | 1.3 | 1.3 |
| | Vit. K1 (μg) | 8 | 8 | 8 |
| | Vit. C (mg) | 15 | 15 | 15 |
| | Vit. B1 (mg) | 0.07 to 0.1 | 0.07 to 0.1 | 0.1 |
| | Vit. B2 (mg) | 0.1 | 0.1 | 0.1 |
| | Niacin (mg) | 0.5 | 0.5 | 0.5 |
| | Vit. B6 (mg) | 0.05 | 0.05 | 0.05 |
| | Folic acid (μg) | 15 to 16 | 15 to 16 | 15 |
| | Pantothenic | 0.7 to 0.8 | 0.7 to 0.8 | 0.8 |
| | Acid (mg) | | | |
| | Vit. B12 (μg) | 0.2 | 0.2 | 0.2 |
| | Biotin (μg) | 2 | 2 | 2 |
| | Choline (mg) | 20 | 20 | 20 |
| | Inositol (mg) | 25 | 25 | 20 |
| | Taurine (mg) | 8 | 8 | 6 |
| | Carnitine (mg) | 1.5 | 1.5 | — |

### Example 2

An array of age-tailored infant formulae is given in the table below:

| | 0 to 2 months | 2 to 6 months | 6 to 12 months |
|---|---|---|---|
| Nutrient | per 100 kcal | per 100 kcal | per 100 kcal |
| Energy (kcal) | 100 | 100 | 100 |
| Protein (g) | 1.83 | 1.83 | 1.83 |
| Fat (g) | 5.3 | 5.3 | 5.3 |
| Linoleic acid (g) | 0.79 | 0.79 | 0.79 |
| α-Linolenic acid (mg) | 101 | 101 | 101 |
| Lactose (g) | 11.2 | 11.2 | 11.2 |
| Minerals (g) | 0.37 | 0.37 | 0.37 |
| Na (mg) | 40 | 23 | 21 |
| K (mg) | 100 | 80 | 75 |
| Cl (mg) | 64 | 64 | 64 |
| Ca (mg) | 100 | 96 | 92 |
| P (mg) | 46 | 41 | 37 |
| Ca/P ratio | 2.17 | 2.34 | 2.48 |
| Mg (mg) | 7 | 7 | 7 |
| Mn (μg) | 8 | 8 | 8 |
| Se (μg) | 2 | 2 | 2 |
| Vitamin A (μg RE) | 105 | 105 | 105 |
| Vitamin D (μg) | 1.5 | 1.5 | 1.5 |
| Vitamin E (mg TE) | 0.8 | 0.8 | 0.8 |
| Vitamin K1 (μg) | 8 | 8 | 8 |
| Vitamin C (mg) | 10 | 10 | 10 |
| Vitamin B1 (mg) | 0.07 | 0.07 | 0.07 |
| Vitamin B2 (mg) | 0.15 | 0.15 | 0.15 |
| Niacin (mg) | 1 | 1 | 1 |
| Vitamin B6 (mg) | 0.075 | 0.075 | 0.075 |
| Folic acid (μg) | 9 | 9 | 9 |
| Pantothenic acid (mg) | 0.45 | 0.45 | 0.45 |
| Vitamin B12 (μg) | 0.3 | 0.3 | 0.3 |
| Biotin (μg) | 2 | 2.2 | 2.2 |
| Choline (mg) | 10 | 10 | 10 |
| Fe (mg) | 1.2 | 1.2 | 1.2 |
| I (μg) | 24 | 15 | 13 |
| Cu (μg) | 95 | 60 | 54 |
| Zn (mg) | 1.25 | 0.65 | 0.58 |
| 3′sialyllactose (mg) | 30 | 30 | 30 |
| 6′sialyllactose (mg) | 6 | 6 | 6 |
| LNnT (mg) | 30 | 30 | 30 |
| 2FL (g) | 0.3 | 0.3 | 0.3 |

1. An infant formula designed to meet the nutritional requirement of an infant and having a phosphorus source and a calcium source such that the calcium:phosphorus ratio is from 2.0:1 to 2.5:1.

2. An age-tailored nutrition system for an infant, comprising:
a first infant formula designed to meet the nutritional requirement of an infant from birth to two months and having a phosphorus source and a calcium source such that the calcium:phosphorus ratio is between 1.0:1 and 2.5:1; and
a second infant formula being designed to meet the nutritional requirement of an infant from above two to six months and having a phosphorus source and a calcium source such that the calcium:phosphorus ratio is between 1.0:1 and 2.5:1; and
wherein the calcium:phosphorus ratio in the second infant formula is higher than that in the first infant formula and wherein at least one of the first and second infant formula has a calcium:phosphorus ratio from more than 2.0:1 to 2.5:1.

3. An age-tailored nutrition system according to claim 2, wherein the phosphorus content in the first infant formula is between 70 and 42 mg/100 kcal, and the calcium content is between 140 and 98 mg/100 kcal, the phosphorus content in the second infant formula is between 42 and 38 mg/100 kcal and the calcium content is between 98 and 95 mg/100 kcal.

4. An infant formula according to claim 1, wherein the infant formula comprises at least one additional component selected from the group consisting of lipids, minerals other than calcium and phosphorus probiotics prebiotics, proteins, carbohydrates, and mixtures thereof.

5. An infant formula according to claim 4, wherein the lipid is selected from the group consisting of long-chain polyunsaturated fatty acids, medium-chain triglycerides, milk fat globule membranes, and mixtures thereof.

6. An age-tailored nutrition system according to claim 4, wherein the content of at least one minerals selected from calcium, iodine, phosphorus, potassium, sodium, copper and zinc in the second infant formula is lower than that in the first infant formula.

7. An infant formula according to claim 4, wherein the infant formula comprises whey from 100:0 to 40:60.

8. An age-tailored nutrition system according to claim 2, wherein the ratio of whey and casein in the first infant formula is between 100:0 and 60:40 and the protein content is between 2.0 and 3.0 g/100 kcal, and the ratio of whey and casein in the second infant formula is between 70:30 and 50:50 and the protein content is between 1.7 and 2.1 g/100 kcal, with the proviso that either the protein content or the whey:casein ratio of the second formula or both is/are lower than for the first formula.

9. An infant formula according to claim 1, wherein the infant formula is in the form of a powder to be reconstituted or a concentrate to be diluted.

10. A method for improving bone development of infants from birth comprising administering a composition comprising an infant formula designed to meet the nutritional requirement of an infant and having a phosphorus source and a calcium source such that the calcium:phosphorus ratio is from 2.0:1 to 2.5:1 to the infant.

11. A method of providing nutrition to an infant, comprising:
feeding to the infant an age-tailored nutrition system for an infant, comprising:
a first infant formula designed to meet the nutritional requirement of an infant from birth to two months and having a phosphorus source and a calcium source such that the calcium:phosphorus ratio is between 1.0:1 and 2.5:1; and
a second infant formula being designed to meet the nutritional requirement of an infant from above two to six months and having a phosphorus source and a calcium source such that the calcium:phosphorus ratio is between 1.0:1 and 2.5:1; and
wherein the calcium:phosphorus ratio in the second infant formula is higher than that in the first infant formula and wherein at least one of the first and second infant formula has a calcium:phosphorus ratio from more than 2.0:1 to 2.5:1.

12. (canceled)

13. An age-tailored nutrition system for an infant, comprising:
a first infant formula designed to meet the nutritional requirement of an infant from birth to two months and having a phosphorus source and a calcium source such that the calcium:phosphorus ratio is between 1.0:1 and 2.5:1;
a second infant formula designed to meet the nutritional requirement of an infant from above two to six months and having a phosphorus source and a calcium source such that the calcium:phosphorus ratio is between 1.0:1 and 2.5:1, preferably from more than 2.0:1 to 2.5:1;
a third infant formula being designed to meet the nutritional requirement of an infant from above six to twelve months and having a phosphorus source and a calcium source such that the calcium:phosphorus ratio is between 1.0:1 and 2.5:1; and
wherein the calcium:phosphorus ratio in the second infant formula is higher than that in the first infant formula, and the calcium:phosphorus ratio in the third infant formula is higher than that in the second infant formula, and wherein at least one of the first, second and third infant formula has a calcium:phosphorus ratio from more than 2.0:1 to 2.5:1.

14. An age-tailored nutrition system according to claim 2, wherein the phosphorus content in the first infant formula is between 70 and 42 mg/100 kcal, and the calcium content is between 140 and 98 mg/100 kcal, the phosphorus content in the second infant formula is between 42 and 38 mg/100 kcal and the calcium content is between 98 and 95 mg/100 kcal, the phosphorus content is lower than 38 mg/100 kcal and/or the calcium content is lower than 95 mg/100 kcal in the third infant formula.

15. An age-tailored nutrition system according to claim 2, wherein the first, the second and the third infant formula of the age-tailored nutrition system comprises at least one additional component selected from the group consisting of lipids, minerals other than calcium and phosphorus, probiotics, prebiotics, proteins, carbohydrates, and mixtures thereof.

16. An age-tailored nutrition system according to claim 15, wherein the content of at least one mineral selected from calcium, iodine, phosphorus, potassium, sodium, copper and zinc in the second infant formula is lower than that in the first infant formula.

17. An infant formula according to claim 2, wherein the infant formula or each of the first and the second infant formula of the age-tailored nutrition system comprises whey and casein, the whey:casein ratio being chosen in the range from 100:0 to 40:60.

18. An age-tailored nutrition system according to claim 2, wherein the infant formula or each of the first and the second infant formula of the age-tailored nutrition system is in the form of a powder to be reconstituted or a concentrate to be diluted.
